(19) United States
(12) Patent Application Publication
(10) Pub. No.: US 2021/0302030 A1
(43) Pub. Date: Sep. 30, 2021

(54) COMMERCIAL BUILDING SOLAR HEATING SYSTEM

(71) Applicant: William J. Hudson, Washington, MI (US)

(72) Inventor: William J. Hudson, Washington, MI (US)

(21) Appl. No.: 17/264,239

(22) PCT Filed: Jul. 31, 2019
(86) PCT No.: PCT/US2019/044493

§ 371 Date: Jan. 28, 2021

Related U.S. Application Data
(60) Provisional application No. 62/712,664, filed on Jul. 31, 2018.

(51) Int. Cl. F24D 5/00; F24D 5/04; F24S 10/50; F24S 20/67; F24S 25/11; F24S 25/20

(52) U.S. Cl. CPC F24D 5/005; F24D 5/04; F24S 10/503; F24D 2200/14; F24S 25/11; F24S 25/20; F24S 20/67

(57) ABSTRACT

An improved commercial solar space heater system for a commercial building consisting of a plurality of solar-energy absorbing units atop the roof of the building providing passive solar heating. Each unit includes a frame having sides defining a heat chamber between a top plate and an absorber as well as an insulating pocket between an inner wall and a support. The heat chamber is enclosed except for an inlet and outlet through which air is directed to be heated. A housing frame holds the frame at an angle conducive to sunray absorption and a curb frame spaces the frame and housing frame from the rooftop when attached to the building. Duct work runs the outlet air from said heat chamber into at least one room of a building and a controller is used for detecting the temperature in the room and directing heat from the outlet into the room when said temperature is below a pre-determined temperature.

### CROSS-REFERENCE TO RELATED APPLICATIONS

This non-provisional patent application claims the benefit of U.S. Provisional Patent Application No. 62/712,664 filed on Jul. 31, 2018. The disclosure of the above application is incorporated herein by reference.

### FIELD OF THE INVENTION

The present invention relates to the field of solar space heating system for heating of multiple suites or spaces of a commercial building.

### BACKGROUND OF THE INVENTION

Solar voltaic panels are widely known and are utilized to create electricity from solar energy. However it is believed that crystalline silica based devices have a theoretical limiting efficiency of roughly 29%.

Additionally, various solar collector designs are utilized for heating water. While heating water can. certainly be accomplished with solar energy, it is believed that eliminating the average water heating cost for a home might translate to a $30 or $40 a month savings. One could perform a cost/benefit analysis to ascertain when the payback of the solar hot water heater might justify the expense. However, solar hot water heaters can be an excellent way to save on energy expenses.

While using solar energy to heat water is certainly one cost saving approach, there are also a limited number of solar space heating systems which have been constructed and installed over the years. In one of the applicant's former companies, Panel-15 from Weirhauser was utilized to fabricate collector boxes and bonnets which connected the collectors to roofs, for at least some installations. A copper sheet was placed in the collector box beneath a top glass. Air was then circulated in between the copper and the glass from an inlet to an outlet, and thus heated air flow was then directed back into the home. This system proved to provide significant energy savings for heating during the daylight hours. Panel 15 is a plywood product having an aluminum layer laminated thereto sold by Weyerhauser.

Commercial applications of solar energy are more complex and require more robust systems for operation to provide an advantage for solar heating benefits. In particular, passive solar heating has not been readily used in commercial buildings. There remains a need in the art for commercially useful solar heating solution.

### SUMMARY OF THE INVENTION

An improved commercial solar space heater system for a multi room commercial building. A plurality of units are used on the roof of a building for providing passive solar heat to the building. Each unit includes a frame having sides defining a heat chamber between a top plate and an absorber. The sides have at least one insulating pocket defined between an inner wall and a support. The heat chamber is enclosed except for an inlet and an outlet through which air is directed to be heated while in the heat chamber. A housing frame is included for holding said frame at an angle conducive to absorbing the suns rays on a roof of a building. The system includes a curb frame attached to the housing frame, or integral therewith, for spacing the frame from the building when it is attached to the building. The curb frame has a base portion which has a flange for attaching the curb to the building. Duct work is provided for running the outlet air from said heat chamber into at least one room of a building. A thermostat or controller is used for detecting the temperature in the room and directing heat from the outlet into the room when said temperature is below a pre-determined temperature.

A use of a plurality of solar heating units is used in the present invention along with a process of control of the plurality of solar collectors.

### BRIEF DESCRIPTION OF THE DRAWINGS

The particular features and advantages of the invention as well as other objects will become apparent from the following description taken in connection with the accompanying drawings in which:

FIG. 1 shows a top perspective view of the presently preferred embodiment of a solar space collector of a presently preferred embodiment of the present invention;

FIG. 2 shows a cross sectional view taken along line A-A of FIG. 1;

FIG. 3 shows a schematic view of the solar collector of FIGS. 1 and 2 installed in a first configuration; and

FIG. 4 shows a schematic view of the solar collector of FIGS. 1 and 2 installed in a second configuration;

FIG. 5 shows a view of a commercial solar space heater system for a commercial building in accordance with the present invention;

FIG. 6 is a is a schematic view illustrating a commercial solar space heater system for a commercial building in accordance with the present invention;

FIG. 7 is a view illustrating a commercial solar space heater system for a large open area commercial building in accordance with the present invention;

FIG. 8 is a view illustrating a commercial solar space heater system for a individual room school type commercial building in accordance with the present invention;

FIG. 9 is a view illustrating the curb feature of a commercial solar space heater system for a commercial building in accordance with the present invention

### DETAILED DESCRIPTION OF THE PREFERRED EMBODIMENT

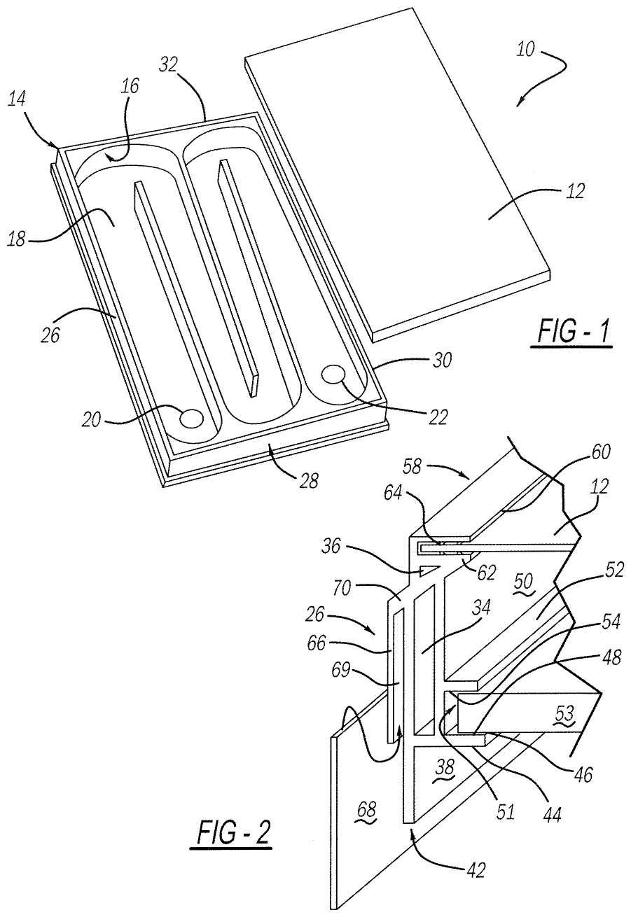

FIG. 1 shows a presently preferred embodiment of a solar collector 10 with its top glass 12 shown removed in an exploded view as it would normally be connected to the frame 14 when in use. This embodiment is presently preferred for space heating applications, in commercial environments where more than 1500 square feet is being heated. A use of a plurality of solar collectors 10 is used in the present invention along with a process of control of the plurality of solar collectors.

The glass 12 may preferably be a. tempered glass such as a low iron tempered glass glazing panel. One preferred embodiment utilizes Soltemp 156 which is believed to be imported from Israel. However, other embodiments may use other glass panels, while with other embodiments translucent and/or transparent glass panels or other materials may be used as may be available or desired. Furthermore, modeled glass may be utilized for some embodiments.

A system of baffles 16 may preferably be located internal to the frame 14 between glass 12 and absorber 18. The baffles 16 may be utilized to increase the length of travel of air flow from an entrance such as inlet 20 to outlet 22 in an effort to increase the amount of heat transfer to the air as it is moved from inlet 20 to the outlet 22 to elevate the temperature of the exiting air. Heated air is normally allowed to rise through the baffles 16. Baffles 16 may increase the length of travel from 1.5×, 2×, 3×, 4×, 5× or other factor. Of course, not all embodiments necessarily require baffles 16. The applicants understand that using baffles 16 often increases heat transferred to the air.

Absorbers 18 could alternately be copper wool or other material(s) in various forms. Copper wool is somewhat similar or dissimilar construction to steel wool which is often utilized preferably in refinishing or other uses. Copper may have attractive material qualities, but for some embodiments other materials in various forms could be utilized in various for absorbers 18. Furthermore, in the presently preferred embodiment, instead of using copper wool, which can be used for some embodiments, a copper foil sheet is utilized. A wool style is not believed to be in use and allows for air through the wool.

In prior art constructions, an eight foot Jong strip of sheer foil was roll formed to provide 0.06 indents to provide an eight foot long absorber. This increased the surface area of the copper foil without significantly increasing its length. In some embodiments, the applicant discovered that greatly increasing the surface area of the absorber may be desirable. In the present preferred embodiment, indents are raised to 0.25 inches and may be provided in some embodiments somewhat similar to a series of folds like “vees.” When manufacturing this style indent, the applicant has been using sixteen foot strips, which after processing, form eight foot lengths for use in the collector 10.

Between the absorber 18 and the top glass 12, and past the baffle 16, if utilized, air flow is directed into an air chamber 24 where the air is heated. Temperature in the air chamber 24 can exceed 400 degrees Fahrenheit on a clear, sunny day for at least some embodiments. Even on a cloudy day, temperatures internal to the heat chamber 24 could exceed 200 degrees Fahrenheit for at least some embodiments.

A cross section of a presently preferred side or frame member 26 can be seen with reference to FIG. 2. Other frame members 28, 30, 32 may be similarly or dissimilarly constructed. Frame member 26 may be an extruded HDPE (high density polyethylene) or other material. Frame member 26 may also be manufactured by other methods other than extrusion. However, extrusion has been found to be a particularly cost effective while providing high quality frame members 26. Frame member 26 preferably has at least one, if not a plurality, of insulating portions such as pockets 34, 36 illustrated, which may preferably provide additional insulating capability to facilitate reduction of heat loss through the frame members 26-32 so that the heat collected in the heat chamber 24 is directed to the outlets 22 and thus utilized for heating instead of being lost external to the frame 14 as will be described in further detail below and has occurred with prior art designs. Other insulation techniques may be employed with various embodiments.

The frame member 26 preferably has a support 38 with a lower portion 40. Support 38 can be utilized to space a bottom 42 from a lower surface 44 of extension 46 if utilized. Pockets 34 may be at least partially located between support 38 and inner wall 50. Extension 46 may also have an upper surface 48 which can extend from support 38 and also provide a base for inner wall 50 if utilized. Air pocket 34 can provide additional insulation for at least some embodiments.

A ledge 52 may or may not be provided. When a ledge 52 is provided, a lower surface of the ledge 52 may cooperate with the upper surface 48 and the extension 46 to provide a slot 51 which may allow the insertion of insulation 53 such as one inch Thermax or other appropriate insulating material on top of insulation. Of course, the insulation 53 could also be provided below the extension 46, if utilized, including in other embodiments. Above the insulation is preferably located the absorber 18 such as can rest on the insulation 53, an upper surface 56 of the ledge 52 or elsewhere such as on the insulation 53, etc. Baffle 16 may then be located there atop and/or above, if utilized, to cooperate therewith as explained above and would be understood by those of ordinary skill in the art. Baffle 16 preferably extends to span substantially the elevation between the top glass 12 and at least atop of the absorber 18 for many embodiments, and may be constructed of an appropriate material capable of handling the temperatures to which it is expected to be exposed.

The glass 12 may be retained to the support 38 by a retainer 58 preferably has upper and lower jaw members 60, 62. Jaw members 60, 62 preferably extend less than 0.7 inches such as 0.65 to provide a grip on the glass 12 of no more than about 0.5 inches at the edges. This is believed to be a significant improvement over prior art designs which maintain an inch of aluminum covering the edges. Therefore in a typical four foot by eight foot construction, approximately two square feet of additional collection area is provided. Furthermore, internal to the jaw members 60, 62, it is preferably grip 64 which could be a dual durometer applied material or other appropriate material such a one or more O-ring(s), etc., which can assist in gripping the retaining glass 12 between the jaw members 60, 62. Other constructions can be utilized in other embodiments.

Lower portion 40 of support 38 can be shaped as designed to provide an angle relative to a roof in an effort to increase the efficiency of the collector 10 for at least some embodiments. Furthermore, the support 38 could be connected to a separate bonnet in a manner similar to former prior art designs. The illustrated configurations could also be connected to a bonnet. Additionally and/or alternatively, downwardly cantilevered extending fin 66 may be utilized to cooperate with roof flashing portion 68 so that the frame 14 may be connected directly to a roof of a building for at least some embodiments without a bonnet. Furthermore, the fins 66 are preferably separated from support 38 such as by slot 69 which may be of sufficient width to accommodate at least two sets of flashing 16 and/or .roof thicknesses such as shingles for at least some embodiments. Fins 66 are preferably cantilevered connected at ankle 70 which may extend outwardly relative to support 38. The fin 66 preferably downwardly extends relative to support 38 and/or ankle 70. The fin 66 extends, for at least some embodiments, at least half of a height of support 38 and may extend substantially the length of the heat chamber 24 for at least some embodiments.

FIG. 3 shows a collector 10 connected to a roof 72. Inlet duct 74 is shown directing air towards inlet 20 as shown in FIG. 1 while outlet duct 76 is shown removing air from the collector 10. Other than inlet 20 and outlet 22, the collector 10 is preferably air tight for many embodiments. A control system 78 may be provided to adjust an amount of air flow such as that controlled by a blower or fan 80 or other mechanisms so that cold air such as taken in at return and/or intake 82 can then be provided through inlet duct 74 to collector 10. Discharge of heated air is directed out of duct 76 from outlet 22 into environment 84 such as around in the house and/or building. Other environments may utilize a blower/fan 80 on the intake side, if blowers are utilized in such embodiments.

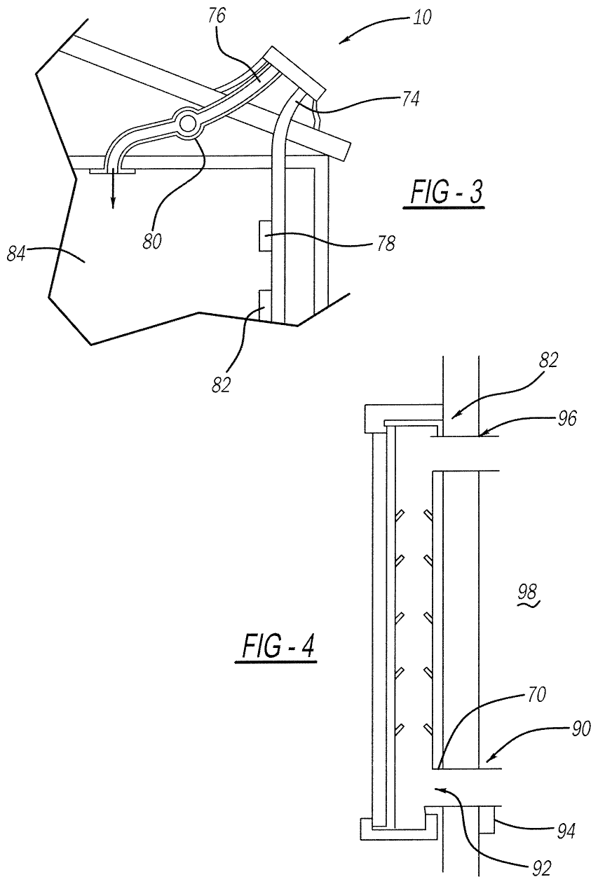

Other embodiments may orient the collector 10 slightly differently such as seen in FIG. 4 where the intake duct 90 cooperates with inlet 20 directing air flow into such as past fan and/or blower 92 as may or may not be controlled by controller 94, if utilized, into the collector 10. Air that passes through the heat chamber 24 is preferably directed out outlet 22 and then outlet duct 96 back into the environment 98. All embodiments do not necessarily utilize blowers 92, as an active system. Some systems are significantly more passive, if not completely passive.

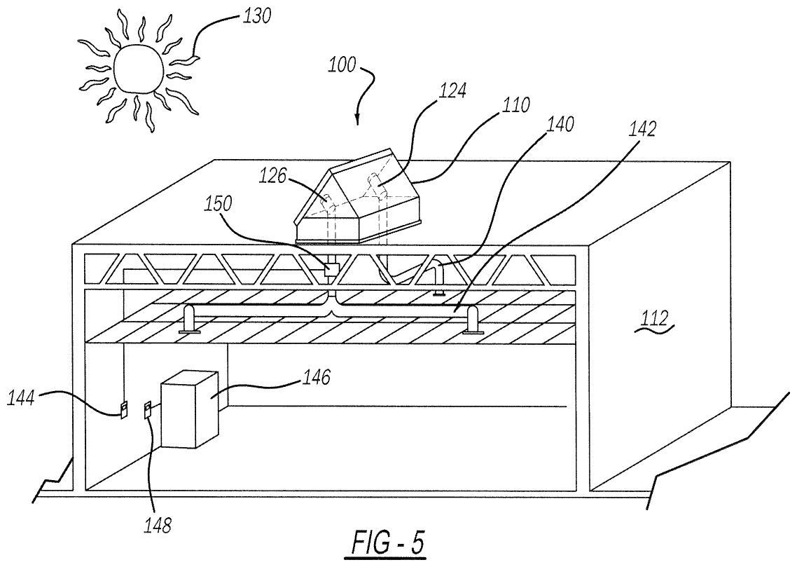

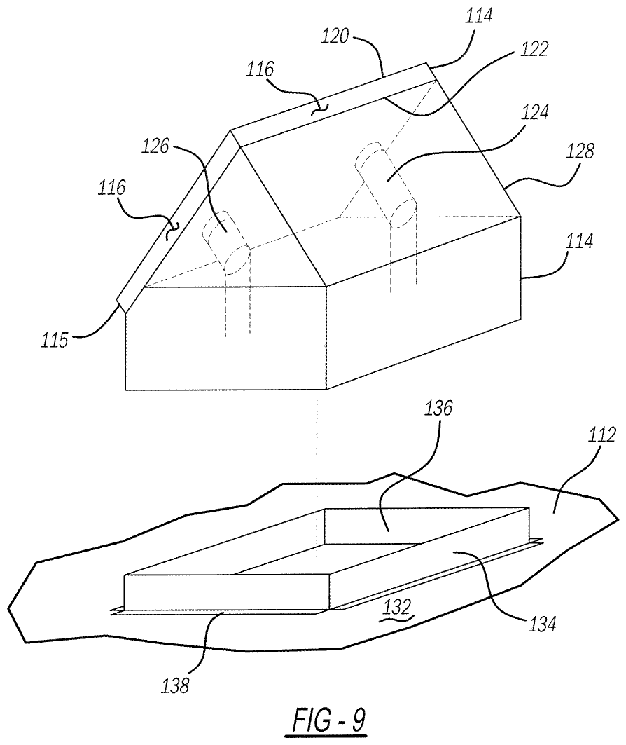

An improved commercial solar space heater system for a commercial building is generally shown in FIGS. 5-9 at 100. One or more but typically a plurality of solar heating units 110, 110a, 110b, 110c-L are used on the roof of a building generally indicated at 112. 112a, and 112b for providing passive solar heat to the building 112, 112a and 112b. Each unit 110 includes a frame 115 having sides 116 defining a heat chamber 118 between a top plate 120 and an absorber 122 as described above. The sides have at least one insulating pocket defined between an inner wall and a support. The heat chamber is enclosed except for an inlet 124 and an outlet 126 through which air is directed to be heated while in the heat chamber 118. A housing frame 128 is included for holding the 115 frame at an angle conducive to absorbing the sun's rays 130 on a roof 132 of a building 112. Referring now to FIGS. 5-9 the system includes a curb frame attached to said housing frame 128, or integral therewith, for spacing the frame 128 from the roof 132 of the building 112 when it is attached to the building 112. The curb frame 134 has a base portion 136 which has an outwardly extending flange for attaching the curb 134 to the building. The curb 134 is about 12″ high and keeps the solar unit out of any snow accumulation on the rough which would be detrimental. The curb 134 is typically made of a galvanized or aluminum sheet metal material and extends about the entire periphery of the unit.

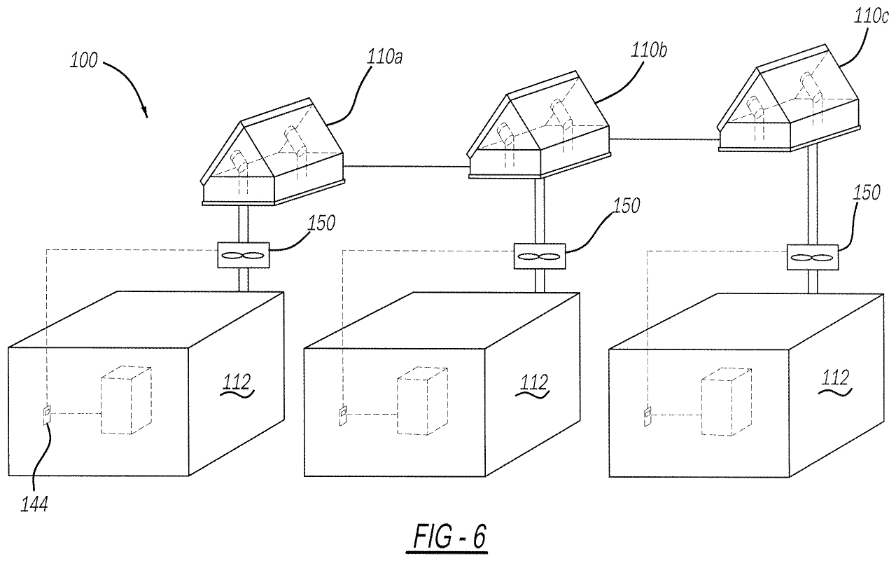

Duct work generally indicated at 140 is provided for running the solar heated outlet air 124 from said heat chamber into at least one room of a building. Ductwork 142 is provided for cold air return air from the room into the solar heating unit 110. A thermostat 144 is used for detecting the temperature in the room and directing heat from the outlet 124 into the room when said temperature is below a pre-determined temperature. In accordance with the process of the present invention, a fuel operated furnace 146 having a thermostat 148 is provided wherein the furnace thermostat 148 is set at a lower temperature than the thermostat 144 such that the furnace 146 will only heat when the solar heating system does not keep the temperature at a higher level than the furnace thermostat 148 such as at night for instance. As shown in FIG. 6 the thermostat 144 can also be of a programmable type wherein it can control both the fans 150 for moving air into the rooms and also the furnace 146 if the temperature falls below a certain predetermined temperature.

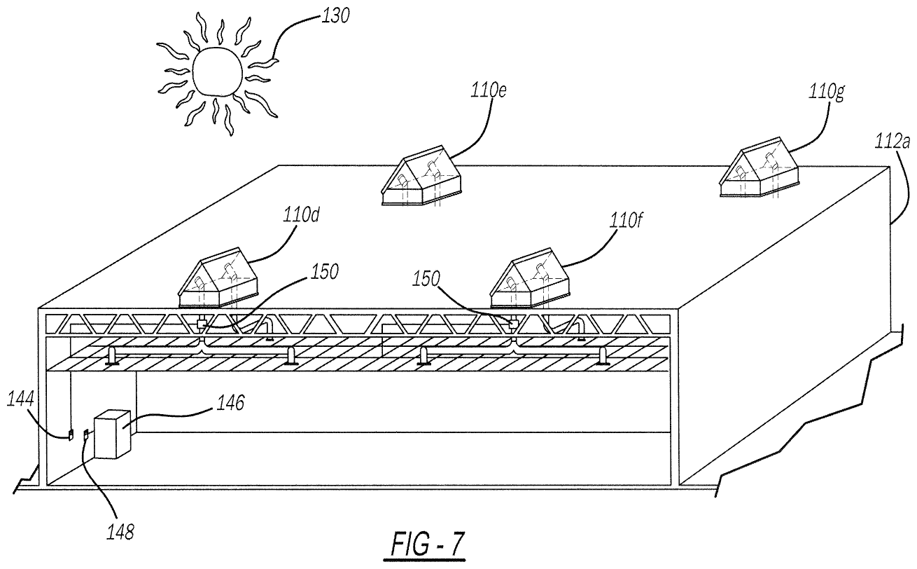

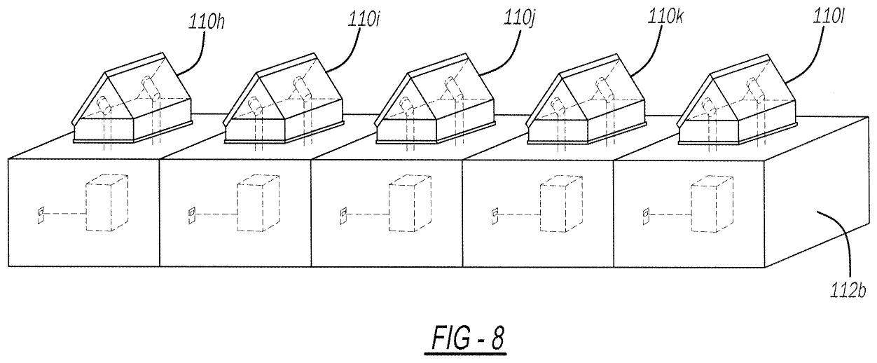

FIG. 7 shows a large open type commercial building, such as a warehouse or big box type store, FIG. 8 shows a multiroom building such as a typical school where units 110h-I are provided in a ratio of 1 unit per class room.

having a space greater than 100 feet where units 110d-g are provided in the building in a ratio of 1 unit per 1000 to 2000 square feet of space and preferably 1 unit per about 1500 square feet of space The present invention has a reinforced framework in the carrier box with 2×2's around all edges.

In accordance with the commercial solar heat system process there is provided a method of supplemental heating of a commercial building comprising the steps of;

a. Installing an improved commercial solar space heater system on a commercial building including a plurality of solar heating units on the roof at least one per 1000-2000 square feet of space. Each of the units is as described above. The process includes setting a thermostat of the existing furnace in the commercial building at a temperature below the setting of the thermostat of the solar heating unit such that the commercial buildings furnace will come on only if the solar heating unit does not heat the building to a level above the temperature of the thermostat of the existing furnace.

The embodiment for commercial buildings includes a thermostat and method wherein the existing thermostat is set at a lower temperature than the solar thermostat. This allows solar heat to be used first for heating with furnace back up. The units are ducted into existing furnace duct work or have duct work separate from existing. A one way valve is used on the inlet 126 and or outlet line 124 is used to open airflow during heating and use of the fans but closing when not in use to avoid hot air going into the duct work when not wanted.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

1. An improved commercial solar space heater system for a commercial building comprising:
a frame having sides defining a heat chamber between a top plate and an absorber, wherein said sides have at least one insulating pocket defined between an inner wall and a support, and said heat chamber being enclosed except for an inlet and an outlet through which air is directed to be heated while in the heat chamber;
a housing frame for holding said frame at an angle conducive to absorbing the suns rays on a roof of a building;
said system including a curb frame being attached to said housing frame for spacing the frame from the building, said curb frame having a base portion which has a flange for attaching the curb to the building;
a duct work for running the outlet air from said heat chamber into at least one room of a building;
a controller for detecting the temperature in the room and directing heat from the outlet into the room when said temperature is below a pre-determined temperature.

2. The improved commercial solar space heater system for a commercial building of claim 1 further comprising at least a second solar space heater which includes the frame housing frame and curb frame and a second outlet connected to said controller.

3. The improved commercial solar space heater system for a commercial building of claim 2 wherein the controller includes a thermostat and a valve member for opening and closing preselected ductwork into a preselected room.

4. The improved commercial solar space heater system for a commercial building of claim 3 further comprising a fan in said second outlet which is controlled by the thermostat for moving warm air into the space to be heated.

5. The improved commercial solar space heater system for a commercial building of claim 4 further comprising a fuel operated furnace having a thermostat wherein the furnace thermostat is set at a lower temperature than the thermostat for the such that the furnace will only heat when the solar heating does not keep the temperature at a higher level than the furnace thermostat.

6. The improved commercial solar space heater system for a commercial building of claim 5 wherein a unit is provided for each 1000-2000 square feet of space.

7. The improved commercial solar space heater system for a commercial building of claim 6 wherein a unit is provided for every 1500 square feet of space in any open areas of said commercial building.

8. The improved commercial solar space heater system for a multi room commercial building of claim 5 further comprising the multiroom commercial building having one solar collector and one thermostat for providing supplemental heating to each room in the building wherein supplemental heat is desired.

9. The improved commercial solar space heater system for a multi room commercial building of claim 1 wherein the curb is a sheet metal spacer attached around the lower periphery of the solar space heater and having a flange extending outward thereof for attachment to a roof of a building.

10. The improved commercial solar space heater system for a multi room commercial building of claim 9 wherein the metal is made of galvanized sheet metal, aluminum or mixtures thereof.

11. The improved commercial solar space heater system for a multi room commercial building of claim 9 wherein a single unit is installed in each room of a commercial building.

12. A method of supplemental heating of a commercial building comprising the steps of:
a. Installing an improved commercial solar space heater system on a commercial building including a plurality of solar heating units on the roof at least one per 1000-2000 square feet of space each of the units including: a frame having sides defining a heat chamber between a top plate and an absorber, wherein said sides have at least one insulating pocket defined between an inner wall and a support, and said heat chamber being enclosed except for an inlet and an outlet through which air is directed to be heated while in the heat chamber; a housing frame for holding said frame at an angle conducive to absorbing the suns rays on a roof of a building; and, a curb frame being attached to said housing frame for spacing the frame from the building, said curb frame having a base portion which has a flange for attaching the curb to the building; a duct work for running the outlet air from said heat chamber into at least one room of a building; and, a thermostat for detecting the temperature in the room and directing heat from the outlet into the room when said temperature is below a pre-determined temperature; and,
b. setting a thermostat of the existing furnace in the commercial building at a temperature below the setting of the thermostat of the solar heating unit such that the commercial buildings furnace will come on only if the solar heating unit does not heat the building to a level above the temperature of the thermostat of the existing furnace.

13. The method of claim 12 wherein the commercial building is a large warehouse type building and one unit is provided for every about 1500 square feet of space.

14. The method of claim 12 wherein a single unit is installed in each room of a commercial building.
